(19) United States
(12) Patent Application Publication
(10) Pub. No.: US 2013/0318056 A1
(43) Pub. Date: Nov. 28, 2013

(54) Lightweight Integrity Protection for Web Storage-Driven Content Caching

(71) Applicants: Sebastian Lekies, Karlsruhe (DE); Martin Johns, Karlsruhe (DE)

(72) Inventors: Sebastian Lekies, Karlsruhe (DE); Martin Johns, Karlsruhe (DE)

(73) Assignee: SAP AG, Walldorf (DE)

(21) Appl. No.: 13/478,991

(22) Filed: May 23, 2012

(51) Int. Cl. G06F 17/30; G06F 15/16

(52) U.S. Cl. 707/697; 707/E17.007

(57) ABSTRACT

Methods, systems, and computer-readable storage media for providing integrity protection for web storage-driven content caching. Implementations include receiving a web page from a server, the web page being associated with a script library and one or more items that can be stored in web storage of a web browser executed on a client computing device, each of the one or more items being associated with a pre-determined checksum value, and loading the script library, such that a local storage API is overwritten using a wrapper function, the script library being executable to, in response to a request for an item from web storage, perform operations including: determining a generated checksum value based on the item, and verifying an integrity of the item based on the generated checksum value and a pre-determined checksum value associated with the item.

### BACKGROUND

In general, web storage summarizes a set of browser-based technologies that enable application-level persistent storage of key/values pairs on the client-side in a client-server architecture. In some examples, these capabilities can be used for caching of markup or script code fragments (e.g., in scenarios with specific bandwidth or responsiveness requirements). Application-level persistent storage of key/values pairs on the client-side is, however, inherently insecure. For example, attackers can be able to inject malicious payloads (e.g., Javascript payloads) into the browser's web storage. Such payloads can reside in the victim's browser for a potentially prolonged period and can lead to resident compromise of the application's client-side code.

### SUMMARY

Implementations of the present disclosure include computer-implemented methods for providing integrity protection for web storage-driven content caching. Implementations include receiving a web page from a server, the web page being associated with a script library and one or more items that can be stored in web storage of a web browser executed on a client computing device, each of the one or more items being associated with a pre-determined checksum value, and loading the script library, such that a local storage API is overwritten using a wrapper function, the script library being executable to, in response to a request for an item from web storage, perform operations including: determining a generated checksum value based on the item, and verifying an integrity of the item based on the generated checksum value and a pre-determined checksum value associated with the item.

In some implementations, verifying an integrity of the item includes comparing the generated checksum value to the pre-determined checksum value.

In some implementations, the script library further includes functionality for, in response to determining that the integrity of the item is compromised: requesting a new version of the item from the server, receiving the new version of the item from the server, storing the new version of the item in web storage, such that the new version of the item is stored in place of the item, and returning the new version of the item in response to the request.

In some implementations, the script library further includes functionality for, in response to determining that the integrity of the item is intact, returning the item in response to the request.

In some implementations, the script library further includes functionality for selectively encoding the item prior to returning the item in response to the request.

In some implementations, the server provides a table of items and associated pre-determined checksum values with the web page.

In some implementations, each of the one or more items is associated with a respective key.

In some implementations, the request indicating a key associated with the item.

In some implementations, the script library further includes: functionality for determining that the key indicates that the integrity of the item is to be verified, wherein determining the generated checksum value and verifying an integrity are performed in response to determining that the key indicates that the integrity of the item is to be verified.

In some implementations, the generated checksum value is determined using a hash function.

In some implementations, the script library is provided as a Javascript library.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example system that can execute implementations of the present disclosure.

FIG. 2 depicts an example process that can be executed in implementations of the present disclosure.

FIG. 3 is a schematic illustration of example computer systems that can be used to execute implementations of the present disclosure.

Like reference symbols in the various drawings indicate like elements.

### DETAILED DESCRIPTION

Implementations of the present disclosure are generally directed to providing lightweight integrity protection for web storage-driven content caching. More particularly, implementations of the present disclosure provide a lightweight library that transparently handles caching and integrity validation for a client-side application that communicates with one or more servers. In some examples, the library is provided as a Javascript library. In some implementations, the library utilizes function wrapping (i.e., a wrapper) to overwrite native storage objects. In some examples, the wrapper implements the same application program interface (API) as the subject web-based application. Consequently, the wrapper can be used by the application as if the wrapper was the original storage object. In some implementations, the wrapper provides a plurality of keys that are used for code caching and checksums for corresponding code fragments. In some implementations, when the application requests an entry with a key from the plurality of keys, the wrapper calculates the checksum of the entry and compares the calculated checksum to a checksum received from a server (e.g., a server responding to requests from the client-side). If the checksums match, the requested data is passed on to the application. If the checksums do not match, the script contacts the server and requests a new version of the cached code. The new version of the cached code is stored within the web storage and is made available to the application.

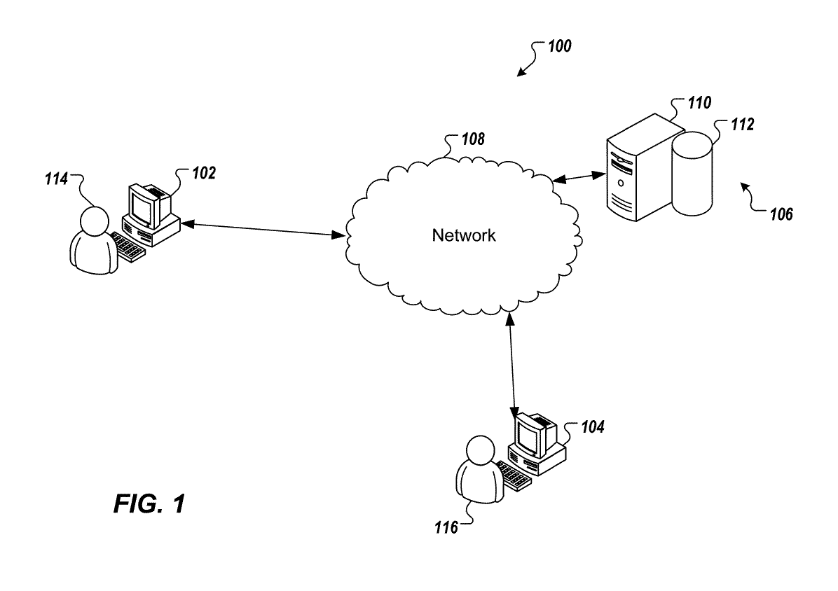

FIG. 1 depicts an example system 100 that can execute implementations of the present disclosure. The example system 100 includes a first computing device 102, a second computing device 104, a server system 106 and a network 108. The first and second computing devices 102, 104 can each include any appropriate type of computing device such as a desktop computer, a laptop computer, a handheld computer, a tablet computing device, a personal digital assistant (PDA), a cellular telephone, a network appliance, a camera, a smart phone, an enhanced general packet radio service (EGPRS) mobile phone, a media player, a navigation device, an email device, a game console, or a combination of any two or more of these data processing devices or other data processing devices. In the example system 100 of FIG. 1, the computing devices are depicted as desktop computers.

The computing devices 102, 104 can communicate with one another and/or the server system 106 over the network 108. The network 108 can include a large computer network, such as a local area network (LAN), a wide area network (WAN), the Internet, a cellular network, or a combination thereof connecting any number of mobile computing devices, fixed computing devices and server systems. The server system 106 can include one or more computing devices 110 and one or more machine-readable repositories, or databases 112.

For purposes of illustration, and as discussed in further detail below, a user 114 can use the first computing device 102 to interact with a web-based application that is hosted by the server system 106. In some examples, interaction between the first computing device 102 and the server system 106 includes the use of web storage. A user 116 using the second computing device 104 can be a malicious user that seeks to exploit potential vulnerabilities of the interaction between the computing device 102 and the server system 106. As discussed in further detail herein, implementations of the present disclosure inhibit attacks that exploit inherent vulnerabilities in web storage.

Before discussing details of implementations of the present disclosure, use cases of web storage and vulnerabilities of web storage will be briefly discussed. In this manner, a general context will be provided to assist in understanding the details and benefits of implementations of the present disclosure.

In general, web storage is a mechanism that enables a piece of a script (e.g., Javascript) to store structured data within a web browser that is executed on a client-side computing device (e.g., the first computing device 102 of FIG. 1). In this context, web storage is an umbrella term for related functionalities. Example functionalities include session storage (SessionStorage) and local storage (LocalStorage), each of which are discussed in further detail below. In some examples, each of these functionalities implements the same API and adheres to the same security restrictions. In some examples, the underlying storage mechanism is provided via a key-item scheme that enables the storage, retrieval and deletion of an item (e.g., a string value) based on a particular key. An example script for LocalStorage can be provided as:

<script>

//Set Item
localStorage.setItem(“foo”,“bar”);
...
//Get Item
var testVar = localStorage.getItem(“foo”);
...
//Remove Item
localStorage.removeItem(“foo”);
...
//Clear all
localStorage.clear( );

</script>

In general, access to data stored within web storage is limited to the same origin resources only. More particularly, each web site accessed by the client-side browser is assigned a particular storage area. In this manner, data of different origins can be strictly separated. For example, data stored by a web site in the domain a.net is only accessible to other resources from a.net, but is not accessible to resources from the domain b.net.

In general, SessionStorage supports transaction-based scenarios in which a user is able to simultaneously carry out the same transaction in multiple browser windows. In some examples, and within the same window, data can be stored and retrieved from the storage by any web page loaded from the same origin (e.g., domain). A web page loaded within another window is assigned different storage and is unable to access data from other windows.

In general, LocalStorage differs from SessionStorage in respect to scope and lifetime. For examples, and as opposed to SessionStorage, data within LocalStorage can also be accessed across different browser windows by web pages having an origin in common. Furthermore, LocalStorage is persistent across sessions, while data within SessionStorage is discarded whenever the corresponding session is closed.

Another example storage includes global storage (GlobalStorage). In general, GlobalStorage holds multiple private storage areas that can be accessed over a longer period of time across multiple pages and sessions.

Example use cases for web storage will be discussed in detail. Example use cases can include keeping state of a session in offline situations and using web storage for caching purposes. With regard to keeping state of a session, some web browsers enable web-based applications to provide offline capabilities. For this, the application can explicitly specify which of its web resources should be kept in the application cache of the web browser. In some examples, this is achieved using a dedicated manifest file that lists one or more uniform resource locators (URLs) associated with resources (e.g., web pages) that are to be stored. In situations where the web browser is disconnected from the network, previously stored files can be loaded and rendered from the application cache (appcache). However, and because no network connection is present to propagate user actions to the server(s) hosting the web-based application, all actions that might have a permanent effect can be temporarily stored in the web browser until the web browser reenters the online mode. Web storage enables such temporary, offline storage.

With regard to controlled caching of web content, example caching facilities of web browsers only enable caching content of complete responses (e.g., hypertext transfer protocol (HTTP)) responses). In some examples, complete responses can include complete documents (e.g., web pages), scripts, images and/or other digital content. Furthermore, the actual caching process is transparent to the application and is not under control of the application. Consequently, and in situations where there is a need to either cache only sub-parts of hypertext mark-up language (HTML) documents or the application needs closer control over the cached content and its usage, web storage provides the needed capabilities. This is particularly appreciated in the context of web applications that target mobile devices, which might have to deal with limited network bandwidth and high network latency.

In view of the example use cases discussed above, an example use case and example vulnerabilities of web storage will be discussed. Example vulnerabilities can include cross-site scripting (XSS), untrustworthy networks, and shared web browsers. Each is discussed in further detail below. In general, and as discussed below, each of the example vulnerabilities includes malicious scripts executed in the victim's web browser, which manipulates code fragments held in web storage. This action performed on the client-side without any involvement of the server-side component of the web application.

For purposes of illustration, an example use case for web storage includes application-level content caching. In this context, applications can use web storage for caching web page components, for example. Example web page components can includes HTML fragments, cascading style sheets (CSS) styles, and/or Javascripts, which are meant to be included verbatim into the web page after retrieval from web storage. An example script for this use case can be provided as:

<script>
if (cached) {

var fragment = localStorage

.getItem(“analytics”);

document.write(fragment);

} else {

[retrieve code over the network]

}
</script>

At first blush, this behavior might be considered safe. A web site's web storage is isolated from untrusted parties via the same-origin policy. For example, the same-origin policy can provide that only JavaScript, which is executed within the application's origin, is allowed to access or modify the content stored in web storage. However, a vulnerability arises in situations where a malicious user might be able to temporarily circumvent this protection and is able to elevate a temporary breach (e.g., through a reflected XSS vulnerability) into a persistent compromise of the web application's client-side code. For example, by inserting JavaScript code into one of the web site's code fragments, which are stored in web storage, the malicious user can ensure that an attack payload is executed every time the victim accesses the web application with the web browser (potentially for an unlimited amount time). This enables attack payloads that were otherwise not possible (e.g., interception at password entry, continuous user observation). The example vulnerabilities identified above include attack scenarios, in which a malicious user can persist an attack payload (e.g., a script) in the victim's web browser.

With regard to XSS, if an XSS vulnerability exists in the web application, a malicious user is able to permanently inject an attack payload into the web site's web storage. It can be considered insignificant, if this XSS problem is only a reflected XSS that occurs within a section of the web site without sensitive information or interfaces. It can also be considered insignificant, if the targeted user maintains an authenticated state with the web application at the point of time when the attack occurs. The attack could be triggered much later, for example, when the user actively enters the URL of the poisoned web application into the address bar of the web browser. At this time, security aware users might be much less suspicious, as the user did not enter the web site via a manipulated link.

With regard to untrustworthy networks, every time a potential victim uses an untrusted network (e.g., at a local coffee shop), this use can open an opportunity for a malicious user to poison the targeted web browser's web storage. For example, and within the untrusted network, the malicious user can utilize active network-level attack techniques to insert themselves as an intermediary into the victim's HTTP communications. Having achieved this, the malicious user is able to transparently modify the victim's HTTP communications. If the victim directly accesses a web site that uses web storage in an insecure fashion, the malicious user can simply insert an attack payload to modify the web site's storage into one of the web site's legitimate HTTP responses.

Even if the user only visits unrelated web sites and avoids accessing security sensitive web applications while using an untrusted network, this attack is still possible. In such a case, the malicious user can force the web browser to access the vulnerable site through inserting a hidden iframe pointing to the web site into any delivered HTML content. In such cases, the attack payload will patiently reside in the web browser's web storage until later (potentially much later), when the user actively accesses the poisoned web application again. Consequently, the actual exploitation occurs at a point in time, in which the intermediary condition does not exist anymore, and the user operates in a perceived trusted network context.

With regard to shared web browsers, web browsers can be shared by multiple persons (e.g., in the case of Internet cafes or public computers in hotel lobbies). In such situations, a malicious user can insert an attack payload into the web application's web storage. For example, the malicious user can access the web application using the shared browser, and can navigate the web application until a state has been reached in which the application has filled the web browser's web storage with the cached code fragments. At this point, the malicious user can execute script in the context of the loaded web application (e.g., entering a javascript:-URL into the web browser's address-bar). The script is executed under the origin of the web application that is currently displayed in the web browser window (i.e., the targeted application). Consequently, the script has full access to the web site's web storage, allowing the malicious user to insert an attack payload. From this point on, every further user that accesses the web application using this particular web browser will involuntarily execute the malicious script.

Implementations of the present disclosure provide lightweight integrity protection for web storage-driven content caching. The integrity protection of the present disclosure is lightweight in that the underlying script library is easy to deploy and, once deployed on the server-side (e.g., integrated as part of a web page), is transparent to the client-side. Consequently, no modifications to the client-side code are required. In accordance with the present disclosure, integrity checks are provided to validate the legitimacy of stored content. More specifically, whenever an item (e.g., cached code) is retrieved from web storage, a cryptographic checksum is generated (e.g., a generated checksum value), and whether the item was previously received from the server is verified. In some implementations, the server calculates and stores a pre-determined checksum value whenever the server creates a new item that is supposed to be cached within web storage. At each request to a resource that reuses cached items (e.g., cached code), the server includes the pre-determined checksum value in the response. A client-side script determines the generated checksum value of the item received from web storage and compares it to the pre-determined checksum value received from the server. The integrity of the item is verified only if the two checksum values match. The integrity is verified in that it is determined that the item was previously received from the server. The integrity of the item can be determined to be compromised (i.e., was not provided by the server) if the two checksum values do not match.

In further detail, implementations of the present disclosure include a script library (e.g., a Javascript library) that is inserted into a web page associated with a web-based application at design time. In this manner, the script library is loaded to a client-side (i.e., the client that requested the web page) as part of the web page scripting load at runtime. In some implementations, the local storage API is overwritten with the script library using a wrapper function, as discussed in further detail herein. In this manner, functionality of the integrity protection can be provided at the API level. An example wrapping can be provided as:

<script>

var wrapper = new StorageWrapper( );
Object.defineProperty(window, “localStorage”,

{value: wrapper});

</script>

In some implementations, each item that is to be stored using web storage can be associated with a key. In this manner, an item can be retrieved from web storage based on the key. In some examples, whether an integrity of the item is to be checked can also be determined based on the key. For example, a table can be provided that can associate an item with the integrity check based on the key associated with the item. As discussed above, the integrity check includes comparing a pre-determined checksum value to a generated checksum value. If the checksum values match, it is determined that the integrity of the stored item has not been compromised and the item is retrieved from web storage.

If the checksum values do not match, it is determined that the integrity of the stored item has likely been compromised and a new item is requested and received from the server system that hosts the web application. In some examples, the server is contacted (e.g., via XMLHttpRequest, via WebSockets) and a new version of the item is requested, received and stored within the web storage. In some examples, the new version of the item is provided as a copy of the item originally provided by the server. The newly cached item is provided to the web application in response to the original request.

In some examples, the pre-determined checksum value and the generated checksum value are each provided using a hash function (e.g., SHA-256). In some examples, the pre-determined checksum value is calculated in response to receiving a request for the web page that the item is associated with and the pre-determined checksum value can be sent and associated with the item at the client-side (e.g., in the table discussed above). In some examples, the generated checksum value can be determined in response to a request for the item from web storage (e.g., on the client-side). For example, in response to a request for the item from web storage, the hash function can be applied to the item to provide the generated checksum value.

In some implementations, for items that have not been identified for an integrity check (e.g., items not having keys in the table provided from the server), output encoding can be applied before handing the item to the web application. That is, the server did not explicitly express its will to store code within this key-item pair (i.e., the server did not deliver a pre-determined checksum for the particular item). In this manner, caching becomes fully transparent to the web application and at the same time, secure web storage is provided by default. For cases, were the server explicitly wishes to store code that should not be output encoded, a mechanism to opt-out this feature for certain items can be provided.

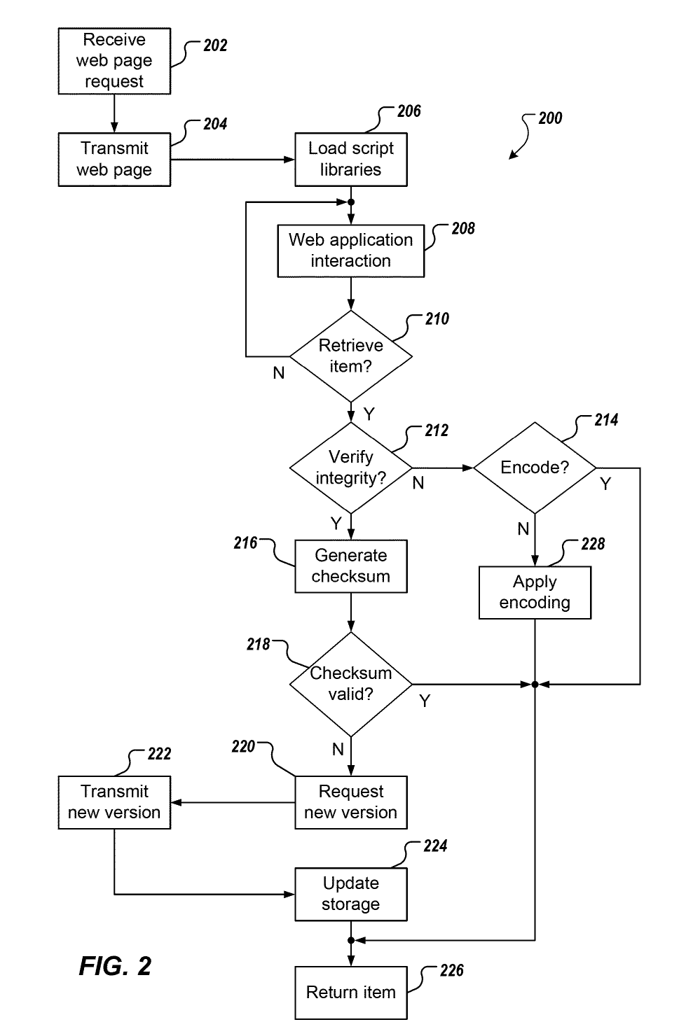

FIG. 2 depicts an example process 200 that can be executed in implementations of the present disclosure. In some examples, the example process can be implemented using one or more computer programs that can be executed using one or more computing devices. For example, the example process 200 can be executed using the computing device 102 and the server system 106 of FIG. 1.

A web page request is received (202). For example, the server system 106 receives a web page request from the computing device 102. The web page is transmitted (204). For example, the server system 106 transmits the web page to the computing device 102. In accordance with the present disclosure, the web page can include one or more script libraries (e.g., Javascript library) and can be associated with one or more items that can be stored in web storage of a web browser executed on the computing device 102. The one or more script libraries can include an integrity check script in accordance with implementations of the present disclosure. The web page is received at the computing device 102.

The one or more script libraries are loaded (206). For example, the web browser executed at the computing device 102 can load the one or more script libraries including the integrity check script. The integrity check script overwrites the local storage API using a wrapper function. An underlying web application is interacted with (208). For example, the user 114 interacts with the web page, which provides an interface to the web application executed on the server system 106.

It is determined whether an item is to be retrieved from web storage of the web browser (210). If an item is not to be retrieved, the example process 200 loops back. If an item is to be retrieved (e.g., an item request including an associated key (GetItem(key)) is received), it is determined whether the integrity of the item is to be verified (212). For example, the integrity check script, functioning at the API level, can receive the request for the item and can determine whether the item is to be retrieved from web storage. In some examples, the integrity check script can determine whether a pre-determined checksum value was provided for the item, and, if a pre-determined checksum value was received for the item, it can be determined that the integrity of the item is to be verified. If the integrity of the item is not to be verified, it is determined whether the item is to be encoded (214).

If it is determined that the integrity of the item is to be verified, a checksum is generated (i.e., the generated checksum value) (216). For example, the integrity check script can use a hash function to provide the generated checksum value based on the item. It is determined whether the generated checksum value is valid (218). For example, the integrity check script compares the pre-determined checksum value and the generated checksum value and, if the checksum values are the same, the generated checksum value is determined to be valid. Otherwise, the generated checksum value is determined to be invalid. If the generated checksum value is determined to be valid, the item is returned (226). For example, the item is returned from web storage for further processing with the web application.

If the generated checksum value is determined to be invalid, a new version (e.g., new copy) of the item is requested from the server (220). For example, the integrity check script can request a new copy of the item from the server. The server can receive the request and, in response, can transmit the new copy of the item (222). Web storage is updated to include the new copy of the item (224). For example, the integrity check script can save the new copy of the item to web storage (in place of the previously stored item). The item is returned (226). For example, the item is returned from web storage for further processing with the web application.

If it is determined that the item is to be encoded (214), encoding is applied to the item (228) and the item is returned (226). If it is determined that the item is not to be encoded, the item is returned (226).

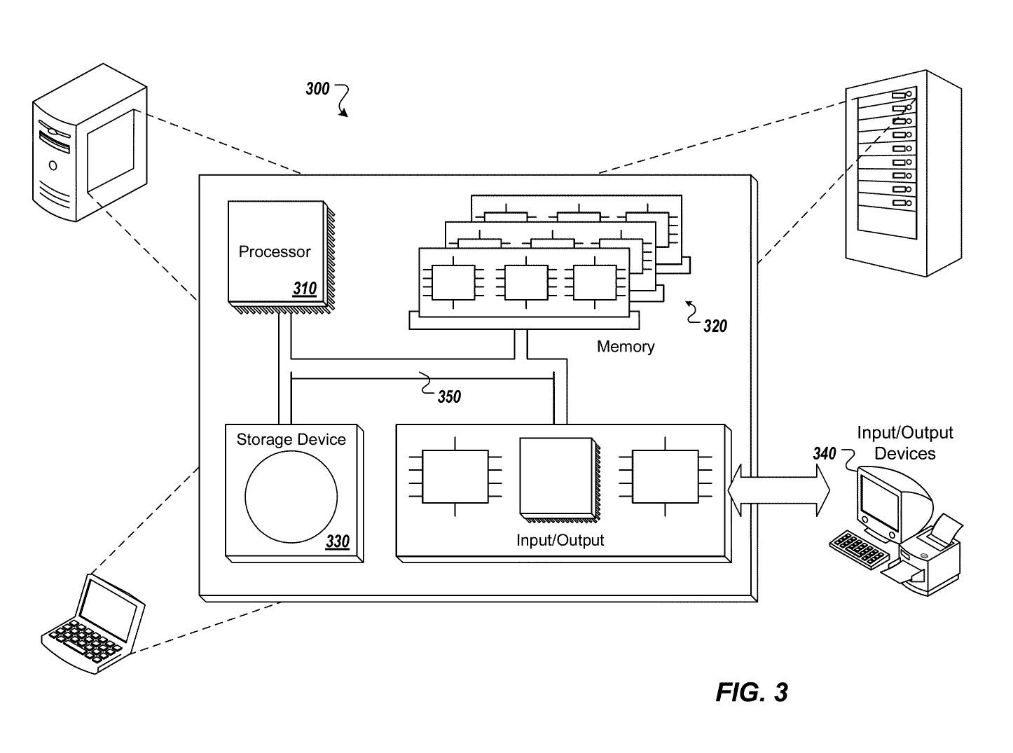

Referring now to FIG. 3, a schematic diagram of an example computing system 300 is provided. The system 300 can be used for the operations described in association with the implementations described herein. For example, the system 300 may be included in any or all of the server components discussed herein. The system 300 includes a processor 310, a memory 320, a storage device 330, and an input/output device 340. Each of the components 310, 320, 330, and 340 are interconnected using a system bus 350. The processor 310 is capable of processing instructions for execution within the system 300. In one implementation, the processor 310 is a single-threaded processor. In another implementation, the processor 310 is a multi-threaded processor. The processor 310 is capable of processing instructions stored in the memory 320 or on the storage device 330 to display graphical information for a user interface on the input/output device 340.

The memory 320 stores information within the system 300. In one implementation, the memory 320 is a computer-readable medium. In one implementation, the memory 320 is a volatile memory unit. In another implementation, the memory 320 is a non-volatile memory unit. The storage device 330 is capable of providing mass storage for the system 300. In one implementation, the storage device 330 is a computer-readable medium. In various different implementations, the storage device 330 may be a floppy disk device, a hard disk device, an optical disk device, or a tape device. The input/output device 340 provides input/output operations for the system 300. In one implementation, the input/output device 340 includes a keyboard and/or pointing device. In another implementation, the input/output device 340 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor receives instructions and data from a read-only memory or a random access memory or both. The essential elements of a computer are a processor for executing instructions and one or more memories for storing instructions and data. Generally, a computer also includes, or is operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for providing integrity protection for web storage for secure content caching, the method being executed using one or more processors and comprising:
receiving, at a client computing device, a web page from a server, the web page being associated with a script library and one or more items that can be stored in web storage of a web browser executed on the client computing device, each of the one or more items being associated with a pre-determined checksum value; and
loading the script library, such that a local storage application program interface (API) is overwritten using a wrapper function, the script library being executable to, in response to a request for an item from web storage, perform operations comprising:
determining a generated checksum value based on the item, and
verifying an integrity of the item based on the generated checksum value and a pre-determined checksum value associated with the item.

2. The method of claim 1, wherein verifying an integrity of the item comprises comparing the generated checksum value to the pre-determined checksum value.

3. The method of claim 1, wherein the script library further comprises functionality for, in response to determining that the integrity of the item is compromised:
requesting a new version of the item from the server;
receiving the new version of the item from the server;
storing the new version of the item in web storage, such that the new version of the item is stored in place of the item; and
returning the new version of the item in response to the request.

4. The method of claim 1, wherein the script library further comprises functionality for, in response to determining that the integrity of the item is intact, returning the item in response to the request.

5. The method of claim 4, wherein the script library further comprises functionality for selectively encoding the item prior to returning the item in response to the request.

6. The method of claim 1, wherein the server provides a table of items and associated pre-determined checksum values with the web page.

7. The method of claim 1, wherein each of the one or more items is associated with a respective key.

8. The method of claim 7, wherein the request indicating a key associated with the item.

9. The method of claim 8, wherein the script library further comprises:
functionality for determining that the key indicates that the integrity of the item is to be verified, wherein determining the generated checksum value and verifying an integrity are performed in response to determining that the key indicates that the integrity of the item is to be verified.

10. The method of claim 1, wherein the generated checksum value is determined using a hash function.

11. The method of claim 1, wherein the script library is provided as a Javascript library.

12. A non-transitory computer-readable storage medium coupled to one or more processors and having instructions stored thereon which, when executed by the one or more processors, cause the one or more processors to perform operations for providing integrity protection for web storage-driven content caching, the operations comprising:
receiving, at a client computing device, a web page from a server, the web page being associated with a script library and one or more items that can be stored in web storage of a web browser executed on the client computing device, each of the one or more items being associated with a pre-determined checksum value; and
loading the script library, such that a local storage application program interface (API) is overwritten using a wrapper function, the script library being executable to, in response to a request for an item from web storage, perform operations comprising:
determining a generated checksum value based on the item, and
verifying an integrity of the item based on the generated checksum value and a pre-determined checksum value associated with the item.

13. A system, comprising:
a computing device; and
a computer-readable storage device coupled to the computing device and having instructions stored thereon which, when executed by the computing device, cause the computing device to perform operations for providing integrity protection for web storage-driven content caching, the operations comprising:
receiving, at a client computing device, a web page from a server, the web page being associated with a script library and one or more items that can be stored in web storage of a web browser executed on the client computing device, each of the one or more items being associated with a pre-determined checksum value; and
loading the script library, such that a local storage application program interface (API) is overwritten using a wrapper function, the script library being executable to, in response to a request for an item from web storage, perform operations comprising:
determining a generated checksum value based on the item, and
verifying an integrity of the item based on the generated checksum value and a pre-determined checksum value associated with the item.
